(19) United States
(12) Patent Application Publication
(10) Pub. No.: US 2015/0252733 A1
(43) Pub. Date: Sep. 10, 2015

(54) AIR INTAKE CONTROL VALVE

(71) Applicant: AISIN SEIKI KABUSHIKI KAISHA, Kariya-shi, Aichi (JP)

(72) Inventors: Toshiyuki Oiwa, Kariya-shi (JP); Masato Ishii, Kariya-shi (JP)

(73) Assignee: AISIN SEIKI KABUSHIKI KAISHA, Kariya-shi, Aichi-ken (JP)

(21) Appl. No.: 14/440,315

(22) PCT Filed: Sep. 24, 2013
(86) PCT No.: PCT/JP2013/075683

§ 371 Date: May 1, 2015

(30) Foreign Application Priority Data
Nov. 19, 2012 (JP) 2012-252873

(51) Int. Cl. F02D 9/10

(52) U.S. Cl. CPC F02D 9/1065; F02D 9/108

(57) ABSTRACT

This air intake control valve includes a valve body provided in an air intake port, a rotating shaft rotating together with the valve body, an actuator generating drive force in a linear direction, a link member having an engaging portion provided on a side opposite to the rotating shaft and an actuator connection portion connected to the actuator, connecting the rotating shaft and the actuator to convert the drive force of the actuator in the linear direction into drive force in a rotational direction and transmit the drive force that has been converted to the rotating shaft, and a retaining portion engaging with the engaging portion to restrict movement of the engaging portion of the link member in an outward direction while allowing rotation of the engaging portion of the link member.

### TECHNICAL FIELD

The present invention relates to an air intake control valve.

### BACKGROUND ART

In general, an air intake control valve rotating a valve body provided in an air intake port about a rotating shaft to open and close the valve body is known. Such an air intake control valve is disclosed in Japanese Patent Laying-Open No. 2000-38930, for example.

In the aforementioned Japanese Patent Laying-Open No. 2000-38930, there is disclosed an air intake control valve including a valve body provided in an air intake path (air intake port), a rotating shaft rotating together with the valve body, an actuator generating drive force in a linear direction, and a link mechanism connecting the rotating shaft and the actuator to convert the drive force of the actuator in the linear direction into drive force in a rotational direction and transmit the converted drive force to the rotating shaft. The link mechanism is constituted by three link members of a tip end portion mounted on an end of the D-cut rotating shaft, a guide member fixed to this tip end portion, and a pin coupling an actuation shaft of the actuator and the guide member. The guide member is coupled to the actuation shaft of the actuator through the pin at a position deviated from the axial center of the rotating shaft and rotates about the axial center of the rotating shaft following linear movement of the actuation shaft. Thus, the drive force of the actuator in the linear direction is transmitted to the rotating shaft through the link members (the pin, the guide member, and the tip end portion).

In the conventional structure disclosed in the aforementioned Japanese Patent Laying-Open No. 2000-38930, a link member (tip end portion) may fall out of the end of the rotating shaft, and hence it is preferable to provide a retaining structure. Particularly in the case where a link member made of resin is mounted on a rotating shaft made of metal in general, the link member easily drops off due to a difference in expansion coefficient, and hence retaining is highly required.

### PRIOR ART

### Patent Document

Patent Document 1: Japanese Patent Laying-Open No. 2000-38930

### SUMMARY OF THE INVENTION

### Problem to be Solved by the Invention

In the case where an engaging structure for retaining is provided between the rotating shaft and the link member, however, additional processing for forming an engagement portion such as a concavity or convexity in the rotating shaft made of metal is required in general. This processing for forming the engagement portion such as a concavity or convexity in the rotating shaft made of metal requires time, and hence the number of processing steps is increased. Thus, it is preferable to retain the link member on the rotating shaft without providing the engaging structure (engagement portion) for retaining in the rotating shaft.

The present invention has been proposed in order to solve the aforementioned problem, and an object of the present invention is to provide an air intake control valve capable of retaining a link member on a rotating shaft without providing an engaging structure for retaining in the rotating shaft.

### Means for Solving the Problem

In order to attain the aforementioned object, an air intake control valve according to an aspect of the present invention includes a valve body provided in an air intake port, a rotating shaft rotating together with the valve body, an actuator generating drive force in a linear direction, a link member having an engaging portion provided on a side opposite to the rotating shaft and an actuator connection portion connected to the actuator, connecting the rotating shaft and the actuator to convert the drive force of the actuator in the linear direction into drive force in a rotational direction and transmit the drive force that has been converted to the rotating shaft, and a retaining portion engaging with the engaging portion to restrict movement of the engaging portion of the link member in an outward direction while allowing rotation of the engaging portion of the link member.

As hereinabove described, the air intake control valve according to the aspect of the present invention is provided with the link member having the engaging portion provided on the side opposite to the rotating shaft and the actuator connection portion connected to the actuator and the retaining portion engaging with the engaging portion to restrict the movement of the engaging portion of the link member in the outward direction while allowing the rotation of the engaging portion of the link member, whereby the link member can be retained by the engagement of the engaging portion of the link member with the retaining portion. Thus, the rotating shaft and the link member can be connected to each other only by fitting the rotating shaft into a hole without forming an engagement portion for retaining in the rotating shaft. Consequently, the link member can be retained on the rotating shaft without providing an engaging structure for retaining in the rotating shaft.

In the aforementioned air intake control valve according to the aspect, the actuator preferably integrally includes the retaining portion. According to this structure, it is not necessary to provide only the retaining portion alone, but the retaining portion can be integrated in the actuator. Therefore, the link member can be retained without providing the engaging structure for retaining in the rotating shaft and without increasing the number of components.

In this case, the actuator preferably includes a case portion made of resin, and the retaining portion is preferably made of resin and is preferably integrally provided in the case portion of the actuator. According to this structure, the retaining portion can be integrally formed at the time of resin molding of the case portion made of resin, and hence the retaining portion can be integrally provided in the case portion (actuator) without additionally processing the case portion (without increasing the number of processing steps).

In the aforementioned air intake control valve according to the aspect, the engaging portion preferably includes a shaft-shaped protrusion portion provided on a rotation centerline of the rotating shaft, having a circular outer periphery, and the retaining portion preferably rotatably supports the shaft-shaped protrusion portion. According to this structure, when the link member transmits the drive force of the actuator to the rotating shaft, the shaft-shaped protrusion portion of the engaging portion can be rotated coaxially with the rotating shaft, and the rotation of the shaft-shaped protrusion portion can be supported by the retaining portion. Thus, in addition to retaining of the link member, the link member can be stably rotated by the rotational support of the retaining portion when the rotating shaft is rotated.

In this case, the retaining portion preferably includes a recess portion having a circular inner peripheral surface rotatably supporting the shaft-shaped protrusion portion having the circular outer periphery and a bottom portion and restricts movement of the link member in the outward direction opposite to the rotating shaft by the bottom portion of the recess portion. According to this structure, the shaft-shaped protrusion portion can be rotatably supported by the inner peripheral surface of the recess portion, and the shaft-shaped protrusion portion (link member) can be retained by the bottom portion of the recess portion. Consequently, by a simple structure of simply forming the recess portion in the retaining portion, the link member can be retained while the link member can be rotatably supported.

In the aforementioned structure in which the retaining portion includes the recess portion, the bottom portion of the recess portion constituting the retaining portion is preferably tapered rearward, and an edge of a tip end portion of the shaft-shaped protrusion portion preferably comes into contact with the bottom portion that is tapered when the shaft-shaped protrusion portion of the link member is moved in the outward direction. According to this structure, also in a state where the link member is retained by the retaining portion, the edge of the tip end portion of the shaft-shaped protrusion portion simply comes into contact with the tapered bottom portion in a line-contact state or in a state close to line contact, and hence an increase in a contact area between the link member and the retaining portion can be suppressed. Consequently, an increase in sliding resistance at the time of rotation of the link member can be suppressed in a state where the link member is retained by the contact of the link member with the retaining portion.

In the aforementioned structure in which the engaging portion includes the shaft-shaped protrusion portion, an end of the link member closer to the rotating shaft is preferably provided with a rotating shaft mounting portion mounted with an end of the rotating shaft, an end of the link member opposite to the rotating shaft is preferably provided with the shaft-shaped protrusion portion, and the rotating shaft mounting portion of the link member preferably has a press-fit hole into which the rotating shaft is pressed and has a circular outer peripheral surface. Furthermore, the air intake control valve preferably further includes a cylindrical slide bearing member rotatably supporting the outer peripheral surface of the rotating shaft mounting portion of the link member, and the rotating shaft mounting portion and the shaft-shaped protrusion portion of the link member are preferably rotatably supported by the slide bearing member and the retaining portion, respectively, such that a structure of bearing both ends of the link member is formed. According to this structure, both ends of the link member are supported by the slide bearing member and the retaining portion so that the link member can be borne. In the case where the rotation of the link member is supported in a cantilever manner by only one bearing provided in a connection between the link member and the rotating shaft, for example, a lateral load (radial load) in a direction orthogonal to the rotating shaft on the side of the link member opposite (tip end side) to the rotating shaft must also be supported by one bearing on the base side, and hence a ball bearing or the like having small sliding resistance must be employed. On the other hand, according to the present invention, a load can be distributed by bearingly supporting both ends of the link member, and hence a slide bearing having a simple structure, being inexpensive as compared with the ball bearing can also be employed to provide sufficiently stable support. Thus, a bearing component of the rotating shaft can be simplified while the reliability of the rotatable support of the link member is ensured.

In the aforementioned air intake control valve according to the aspect, the engaging portion of the link member and the retaining portion are preferably made of resin, and the retaining portion preferably supports the engaging portion to be slidable in the rotational direction. According to this structure, the rotation of the engaging portion is supported by sliding between the resins when the rotation of the engaging portion is supported by the retaining portion, and hence it is not necessary to separately provide a bearing member in the retaining portion. Therefore, the rotation of the engaging portion can be supported by the retaining portion without increasing the number of components.

In the aforementioned air intake control valve according to the aspect, the rotating shaft is preferably made of metal, at least a region of the rotating shaft made of metal on a side to which the link member is connected preferably has the same sectional shape that is not varied, an end of the link member closer to the rotating shaft is preferably mounted with the rotating shaft, and an end of the link member opposite to the rotating shaft is preferably provided with the engaging portion and the actuator connection portion. According to this structure, no engaging structure for the retaining of the link member is formed in the rotating shaft made of metal, and hence the link member can be reliably retained by the engagement of the engaging portion in the end of the link member opposite to the rotating shaft with the retaining portion without increasing the number of processing steps for the rotating shaft made of metal.

According to the present application, in addition to the aforementioned air intake control valve according to the aspect, another structure described below is conceivable.

In other words, an air intake control valve according to another structure of the present application includes a valve body provided in an air intake port, a rotating shaft rotating together with the valve body, an actuator generating drive force in a linear direction, a link member having a rotating shaft mounting portion mounted with the rotating shaft, an actuator connection portion connected to the actuator, and an engaging portion provided on a side opposite to the rotating shaft coaxially with the rotating shaft, connecting the rotating shaft and the actuator to convert the drive force of the actuator in the linear direction into drive force in a rotational direction and transmit the drive force that has been converted to the rotating shaft, a first bearing member rotatably supporting the engaging portion of the link member, and a second bearing member rotatably supporting the rotating shaft mounting portion.

According to this structure, the engaging portion of the link member is arranged on the side opposite to the rotating shaft coaxially with the rotating shaft, the first bearing member rotatably supporting the engaging portion of the link member is provided, and the second bearing member rotatably supporting the rotating shaft mounting portion mounted with the rotating shaft is provided, whereby the link member can be borne from both sides in the axial direction of the rotating shaft by the first bearing member and the second bearing member. Thus, a load can be distributed by rotatably supporting both sides of the link member, and hence rotation of the link member can be stably supported when the rotating shaft is rotated. Therefore, in this air intake control valve according to another structure, rotation of the link member can be stably supported.

In the aforementioned air intake control valve according to another structure of the present application, the first bearing member preferably engages with the engaging portion to restrict movement of the engaging portion of the link member in an outward direction. According to this structure, the link member can be retained by the engagement of the engaging portion of the link member with the first bearing member. Thus, the rotating shaft and the link member can be connected to each other only by fitting the rotating shaft into a hole (rotating shaft mounting portion) without forming an engagement portion for retaining in the rotating shaft. Consequently, the link member can be retained on the rotating shaft without providing an engaging structure for retaining in the rotating shaft.

### Effect of the Invention

According to the aforementioned invention of the aspect, as hereinabove described, the link member can be retained on the rotating shaft without providing the engaging structure for retaining in the rotating shaft.

### BRIEF DESCRIPTION OF THE DRAWINGS

FIG. 1 A perspective view showing the structure of an air intake apparatus including an air intake control valve according to an embodiment of the present invention.

FIG. 2 A partial exploded view showing the internal structure of the air intake apparatus shown in FIG. 1.

FIG. 3 A schematic sectional view of the air intake apparatus shown in FIG. 1 taken along an air intake port.

FIG. 4 A sectional view of the air intake control valve according to the embodiment of the present invention taken along a rotating shaft.

FIG. 5 An enlarged sectional view showing the perimeter structure of a link member of the air intake control valve shown in FIG. 4.

FIG. 6 A front elevational view of the link member shown in FIG. 5.

FIG. 7 A side elevational view of the link member shown in FIG. 5 as viewed in a direction along a rotation centerline.

FIG. 8 A schematic partial sectional view showing a modification of the link member of the air intake control valve according to the embodiment of the present invention.

FIG. 9 A schematic sectional view showing a first modification of an engaging portion and a retaining portion.

FIG. 10 A schematic sectional view showing a second modification of an engaging portion and a retaining portion.

### MODES FOR CARRYING OUT THE INVENTION

An embodiment of the present invention is hereinafter described on the basis of the drawings.

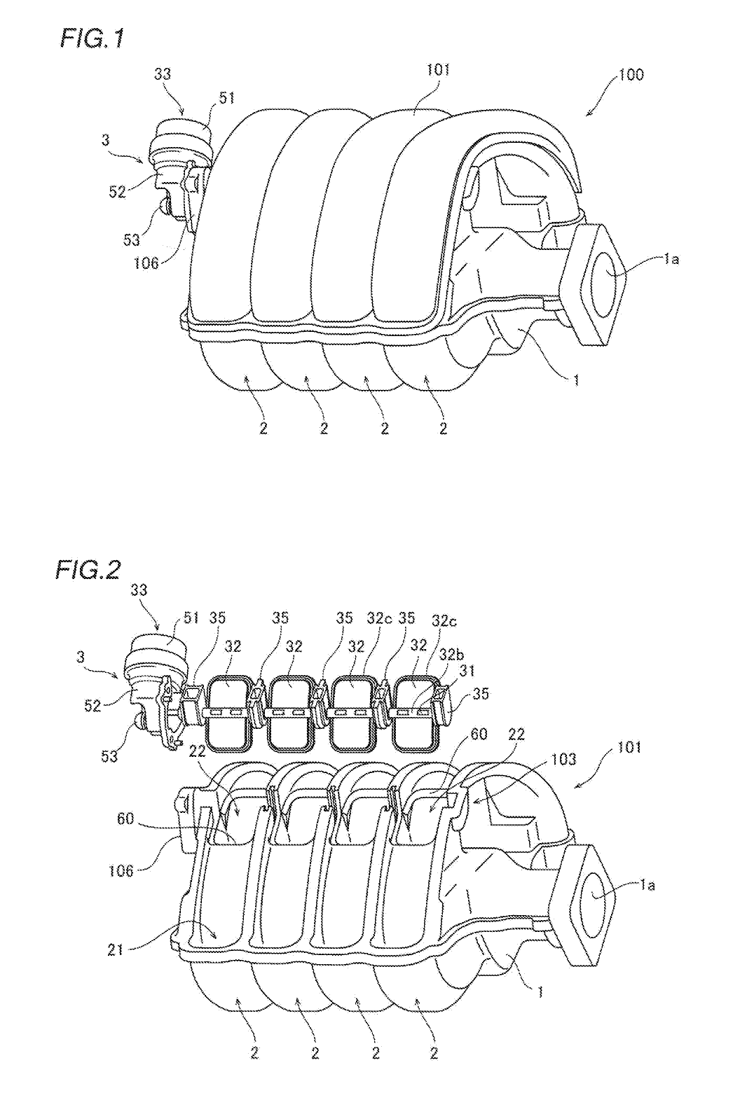

An air intake control valve 3 according to the embodiment of the present invention is described with reference to FIGS. 1 to 7. In this embodiment, an example of applying the present invention to the air intake control valve 3 for changing an air intake path length in an automotive air intake apparatus 100 is described.

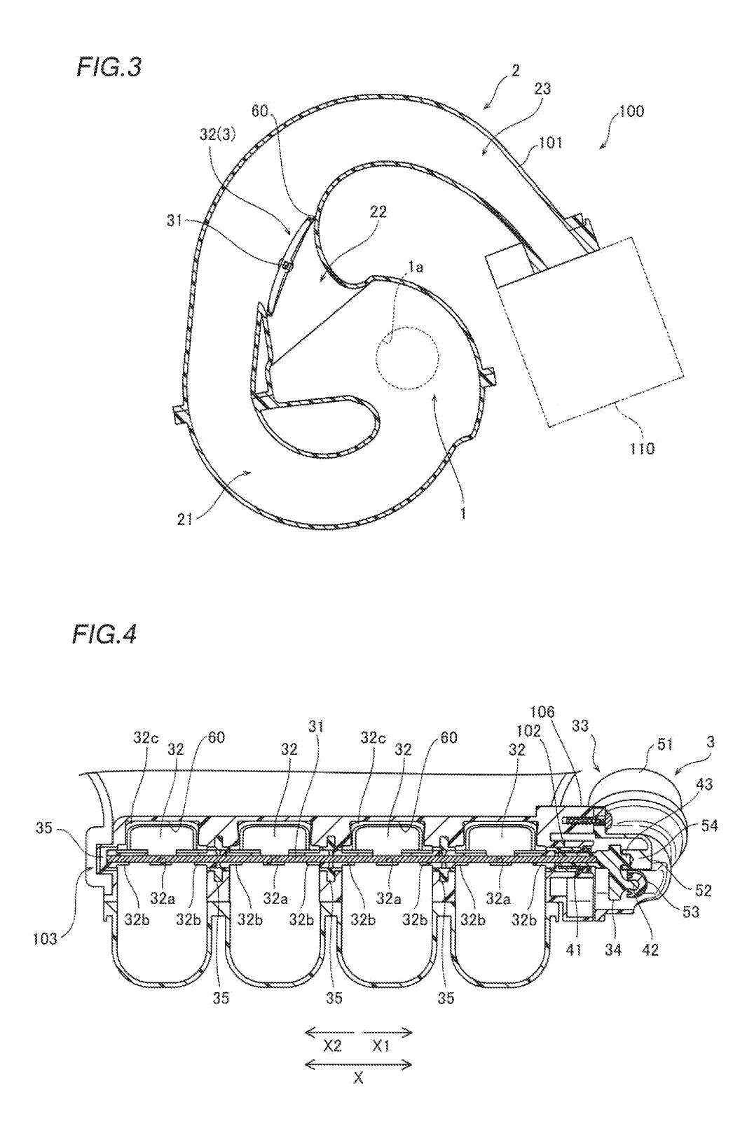

The air intake apparatus 100 is an air intake apparatus provided in an automotive four-cylinder engine, as shown in FIG. 1. The air intake apparatus 100 includes a surge tank 1, four air intake ports 2 branching from the surge tank 1, connected to respective four cylinders of an engine, and the air intake control valve 3 opening and closing valve bodies 32 provided in the respective four air intake ports 2. Structurally, the air intake apparatus 100 includes an air intake apparatus body 101 integrally including the surge tank 1 and the four air intake ports 2, as shown in FIGS. 2 and 3. The air intake control valve 3 (see FIG. 2) is mounted on the inside of the air intake apparatus body 101. The air intake apparatus 100 is connected to a cylinder head 110, and the four air intake ports 2 communicate with each cylinder (not shown) of the engine through the cylinder head 110.

Intake air arriving through an unshown air cleaner and an unshown throttle flows from an inlet 1a into the surge tank 1. Each of the four air intake ports 2 includes a first port portion 21, a second port portion 22, and an outlet port portion 23 connected to a cylinder (cylinder head 110) of the engine on the downstream side of the first port portion 21 and the second port portion 22, as shown in FIG. 3. The first port portion 21 extends to detour not through the air intake control valve 3 from the surge tank 1 and is connected to the outlet port portion 23 on the downstream side. The second port portion 22 is provided to connect the surge tank 1 and the outlet port portion 23 through the air intake control valve 3.

As shown in FIGS. 2 and 3, the air intake control valve 3 is configured to open and close an air passageway 60 arranged at the position of a connection portion between the second port portion 22 and the outlet port portion 23. In other words, a long port having a large air intake path length is formed of the first port portion 21 and the outlet port portion 23 in a state where the air intake control valve 3 closes, and a short port having a small air intake path length is formed of the second port portion 22 and the outlet port portion 23 in a state where the air intake control valve 3 opens, whereby the air intake control valve 3 is configured to be capable of changing the air intake path length. The air intake control valve 3 includes a rotating shaft 31 rotating together with the valve bodies 32, the four valve bodies 32 opening and closing the second port portion 22 (air passageway 60), an actuator 33 rotating the rotating shaft 31, and a link member 34 transmitting the drive force of the actuator 33 to the rotating shaft 31, as shown in FIG. 4. The actuator 33 is a direct acting type negative pressure actuator generating drive force in a linear direction by supply of negative pressure.

The rotating shaft 31 extends in a direction orthogonal to the air intake ports 2 and includes a square shaft passing through four second port portions 22. The rotating shaft 31 is made of metal (stainless steel, aluminum alloy, or the like, for example) and has the same rectangular sectional shape over the entire length. The rotating shaft 31 has one end protruding outward from a mounting hole 102 of the air intake apparatus body 101 and the other end rotatably supported by a supporting portion 103 of the air intake apparatus body 101 through shaft portions 32b of the valve bodies 32 described later and bearing members 35. The extensional axial direction of the rotating shaft 31 is hereinafter referred to as the direction X.

The valve bodies 32 (four in total) are provided in the respective four air intake ports 2. The valve bodies 32 are plate-like members made of resin, having a substantially rectangular outer shape corresponding to that of the air passageway 60. The valve bodies 32 are formed with shaft insertion portions 32a crossing a central portion thereof in a longitudinal direction. The rotating shaft 31 is inserted into the shaft insertion portions 32a, whereby the four valve bodies 32 are mounted on the rotating shaft 31. The inner peripheral surfaces of the shaft insertion portions 32a are in the form of a rectangle corresponding to the outer shape of the rotating shaft 31, and the rotating shaft 31 and the inner peripheral surfaces of the shaft insertion portions 32a come into contact with each other so that the valve bodies 32 rotate integrally with the rotating shaft 31. Both ends of the shaft insertion portions 32a are formed with the shaft portions 32b protruding outward in the axial direction, having circular outer peripheral surfaces, and these shaft portions 32b are inserted into the bearing members 35. Thus, each of the valve bodies 32 is rotatably supported by the bearing members 35.

Circumferential edges of the valve bodies 32 are provided with seal lips 32c made of rubber, whereby the airtightness of the air passageway 60 in a closed state is improved. The air intake control valve 3 is configured to simultaneously perform opening and closing operations of the air passageway (opening) 60 in all the four air intake ports 2 by rotating the rotating shaft 31 to rotate the four valve bodies 32 collectively.

As shown in FIG. 3, in the closed state of the valve bodies 32, the air passageway 60 is closed, whereby intake air introduced into the surge tank 1 is introduced into each cylinder of the engine through the first port portion 21 and the outlet port portion 23 (long port) of each of the air intake ports 2. In an open state of the valve bodies 32, on the other hand, the air passageway 60 is opened, whereby intake air introduced into the surge tank 1 is introduced into each cylinder of the engine through the second port portion 22 and the outlet port portion 23 (short port) of each of the air intake ports 2.

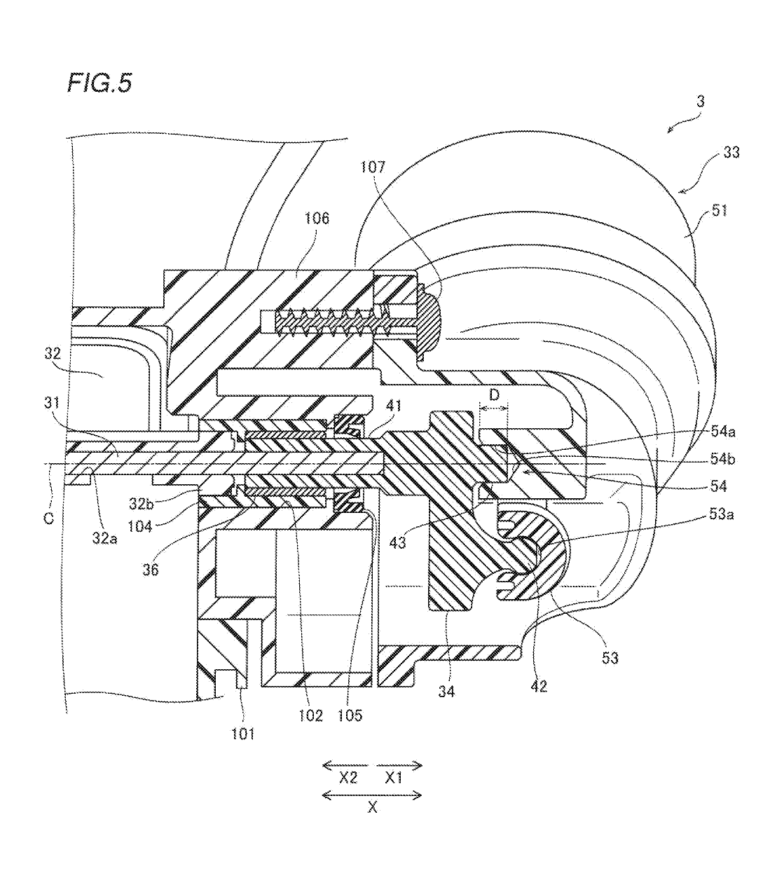

As shown in FIG. 5, the link member 34 is made of resin. For example, polyamide resin (nylon) is employed, and it is preferable to employ glass-fiber reinforced polyamide resin in order to improve mechanical characteristics. The link member 34 connects the rotating shaft 31 and the actuator 33 to convert the drive force of the actuator 33 in the linear direction into drive force in a rotational direction and transmit the converted drive force to the rotating shaft 31.

The link member 34 integrally includes a rotating shaft mounting portion 41 mounted with the rotating shaft 31, a connection portion 42 connected to an actuation piece 53 of the actuator 33, and an engaging portion 43 engaging with a retaining portion 54 of the actuator 33 described later, as shown in FIGS. 5 to 7. The rotating shaft mounting portion 41 is arranged in an end of the link member 34 closer (X2 direction side) to the rotating shaft 31, and the connection portion 42 and the engaging portion 43 are arranged in an end of the link member 34 on an X1 direction side (outside) opposite to the rotating shaft 31. The connection portion 42 is an example of the “actuator connection portion” in the present invention. The engaging portion 43 is an example of the “shaft-shaped protrusion portion” in the present invention.

As shown in FIG. 5, the rotating shaft mounting portion 41 is arranged coaxially on a rotation centerline C of the rotating shaft 31, has a circular outer periphery (cylindrical shaft shape), and is rotatably inserted into the mounting hole 102 of the air intake apparatus body 101. The axial center of the rotating shaft mounting portion 41 is formed with a press-fit hole 41a having a rectangular section (see FIG. 7) corresponding to that of the rotating shaft 31. One end of the rotating shaft 31 is pressed into the press-fit hole 41a, whereby one end of the rotating shaft 31 is mounted on the rotating shaft mounting portion 41. Thus, the rotating shaft 31 and the link member 34 engage with each other in the rotational direction and integrally rotate about the rotation centerline C.

The circular outer periphery of the rotating shaft mounting portion 41 is rotatably borne by a cylindrical slide bearing member 36 made of metal (stainless steel, aluminum alloy, or the like, for example). The slide bearing member 36 is mounted on the inner peripheral side of a cylindrical bush 104 made of resin and is held in the mounting hole 102 of the air intake apparatus body 101 through the bush 104. An outer (X2 direction side) end of this mounting hole 102 is mounted with a seal member 105.

The connection portion 42 is arranged at a position separated from the rotation centerline C of the rotating shaft 31 and has a substantially spherical shape protruding outward (X2 direction side) with respect to the rotating shaft 31. A tip end of the actuation piece 53 of the actuator 33 is formed with a semispherical shell-shaped (concave) connection recess portion 53a, and the connection portion 42 of the link member 34 is fitted into the connection recess portion 53a of the actuation piece 53, whereby the link member 34 is connected to the actuator 33.

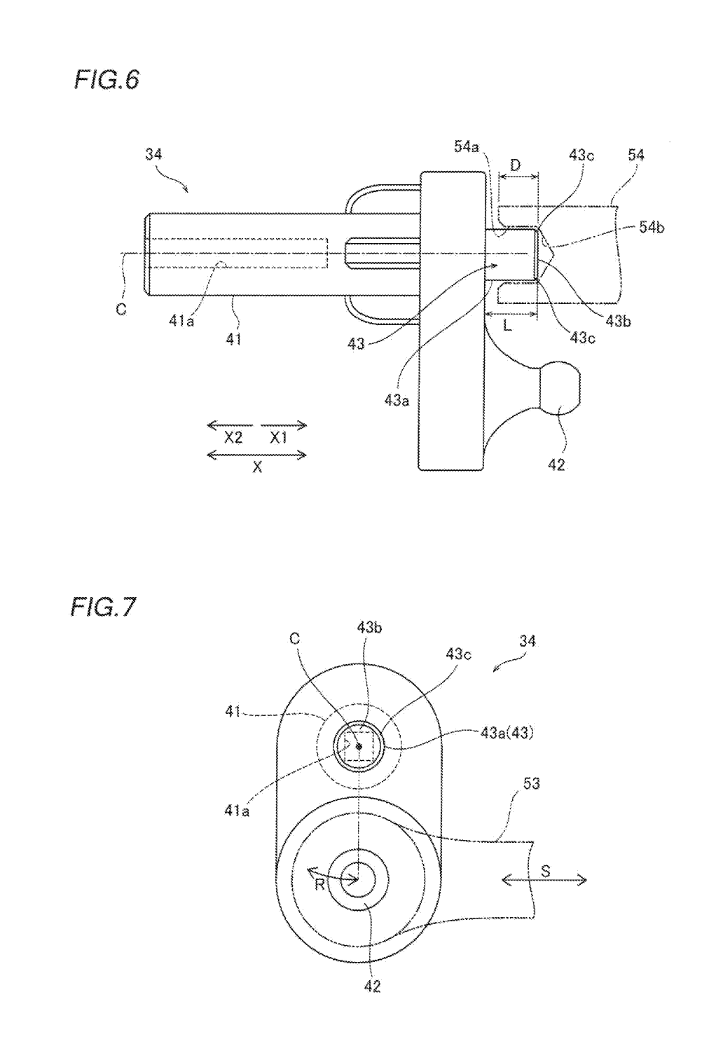

According to this embodiment, the engaging portion 43 is arranged coaxially on the rotation centerline C of the rotating shaft 31, has a circular outer periphery 43a, and includes a shaft-shaped protrusion protruding to a side (X2 direction side) opposite to the rotating shaft 31 (see FIG. 5), as shown in FIGS. 6 and 7. In other words, the engaging portion 43 is in the form of a cylindrical shaft-shaped protrusion. The engaging portion 43 has the circular outer periphery 43a and a flat tip end portion 43b, and an edge 43c of a tip end surface is slightly chamfered. The engaging portion 43 has a protrusion length L from a surface of the link member 34 on the X1 direction side.

As shown in FIGS. 2 and 5, the actuator 33 includes a body portion 51, a case portion 52 supporting the body portion 51, and the actuation piece 53 connected to the body portion 51 and is fixedly mounted on the outside of the air intake apparatus body 101.

The body portion 51 has a structure separated into an atmospheric pressure chamber (not shown) and a negative pressure chamber (not shown) by a diaphragm (not shown). The body portion 51 is configured to move the actuation piece 53 connected to the diaphragm forward and backward in the linear direction S (see FIG. 7, the front side and the rear side of the plane of FIG. 5) by displacing the diaphragm by application of negative pressure to the negative pressure chamber and termination of application of negative pressure. Thus, the actuation piece 53 rotates the link member 34 through the connection portion 42 in a direction R about the rotation centerline C, whereby the rotating shaft 31 opens and closes the valve bodies 32, as shown in FIG. 7.

As shown in FIG. 5, the case portion 52 is made of resin. For example, polyamide resin (nylon) is employed, and it is preferable to employ glass-fiber reinforced polyamide resin. The case portion 52 holds the body portion 51 and is fixedly mounted on a flange portion 106 of the air intake apparatus body 101 by a screw member 107. The case portion 52 is provided to surround and cover the mounting hole 102 of the air intake apparatus body 101. As shown in FIG. 2, a part of the case portion 52 extending in the movement direction of the actuation piece 53 is cut out and is formed not to interfere with the actuation piece 53 (the actuation piece 53 is exposed). The actuation piece 53 is arranged in the case portion 52 in a state where the same can be moved forward and backward in the linear direction S (see FIG. 7) following the actuation of the body portion 51. As shown in FIG. 5, in the case portion 52, the retaining portion 54 engaging with the engaging portion 43 of the link member 34 is integrally formed. The retaining portion 54 is an example of the “recess portion” in the present invention.

According to this embodiment, the retaining portion 54 includes a cylindrical recess portion whose side closer to the rotating shaft 31 is opened, having a circular inner peripheral surface 54a and a bottom portion 54b and extends along a rotating shaft direction. The retaining portion 54 is arranged such that the center of the inner peripheral surface 54a is coaxial with the rotating shaft 31 on the rotation centerline C of the rotating shaft 31. The engaging portion 43 of the link member 34 is inserted into the retaining portion 54, and the retaining portion 54 engages with the engaging portion 43 to restrict movement of the link member 34 in an outward direction (direction X1) opposite to the rotating shaft 31 while allowing rotation (sliding) of the link member 34.

Specifically, the retaining portion 54 is configured to rotatably support the outer periphery 43a of the cylindrical shaft-shaped engaging portion 43 by the circular inner peripheral surface 54a. Therefore, bearing by the retaining portion 54 is sliding between the resin of the engaging portion 43 of the link member 34 made of resin and the resin of the retaining portion 54. In this manner, according to this embodiment, the rotating shaft mounting portion 41 in the end of the link member 34 closer (X2 direction side) to the rotating shaft 31 is rotatably supported by the slide bearing member 36, and the engaging portion 43 in the end of the link member 34 opposite (X1 direction side) to the rotating shaft 31 is rotatably supported by the retaining portion 54, whereby a bearing structure of bearing and supporting both ends of the link member 34 is formed.

The retaining portion 54 is configured to restrict the movement of the link member 34 in the outward direction (direction X1) by the bottom portion 54b of the recessed retaining portion 54. The bottom portion 54b is formed to be tapered rearward (X1 direction side) in the extensional direction X of the rotating shaft 31, and according to this embodiment, the inner surface of the bottom portion 54b is tapered to be conically inclined. As shown in FIG. 6, a depth D from the open side to the bottom portion 54b (the length of the inner peripheral surface 54a in the axial direction) is smaller than the protrusion length L of the engaging portion 43. Thus, when the link member 34 moves in the outward direction (direction X1), the engaging portion 43 deeply enters the retaining portion 54, and the edge 43c of the tip end portion 43b of the engaging portion 43 comes into contact with the inclined bottom portion 54b. Thus, further movement of the link member 34 in the outward direction (direction X1) is restricted (the link member 34 is retained). At this time, the edge 43c of the tip end portion 43b of the engaging portion 43 and the inclined bottom portion 54b come into contact with each other, and hence the engaging portion 43 and the retaining portion 54 are in a substantially line-contact state (a state close to line contact).

According to this embodiment, as hereinabove described, the air intake control valve 3 is provided with the link member 34 having the engaging portion 43 provided on the side opposite to the rotating shaft 31 and the connection portion 42 connected to the actuator 33 and the retaining portion 54 engaging with the engaging portion 43 to restrict the movement of the engaging portion 43 of the link member 34 in the outward direction while allowing the rotation of the engaging portion 43 of the link member 34, whereby the link member 34 can be retained by the engagement of the engaging portion 43 of the link member 34 with the retaining portion 54. Thus, the rotating shaft 31 and the link member 34 can be connected to each other only by fitting the rotating shaft 31 having the same shape over the entire length into the press-fit hole 41a without forming an engagement portion for retaining in the rotating shaft 31. Consequently, the link member 34 can be retained on the rotating shaft 31 without providing an engaging structure for retaining in the rotating shaft 31.

According to this embodiment, as hereinabove described, the retaining portion 54 is integrally provided in the actuator 33. Thus, it is not necessary to provide only the retaining portion 54 alone, but the retaining portion 54 can be integrated in the actuator 33. Therefore, the link member 34 can be retained without providing the engaging structure for retaining in the rotating shaft 31 and without increasing the number of components.

According to this embodiment, as hereinabove described, the retaining portion 54 is integrally provided in the case portion 52 of the actuator 33. Thus, the retaining portion 54 can be integrally formed at the time of resin molding of the case portion 52 made of resin, and hence the retaining portion 54 can be integrally provided in the case portion 52 (actuator 33) without additionally processing the case portion 52 (without increasing the number of processing steps).

According to this embodiment, as hereinabove described, the engaging portion 43 includes the shaft-shaped protrusion provided on the rotation centerline C of the rotating shaft 31, having the circular outer periphery 43a, and the retaining portion 54 is configured to rotatably support the engaging portion 43 including the shaft-shaped protrusion. Thus, when the link member 34 transmits the drive force of the actuator 33 to the rotating shaft 31, the engaging portion 43 can be rotated coaxially with the rotating shaft 31, and the rotation of the engaging portion 43 can be supported by the retaining portion 54. Thus, in addition to retaining of the link member 34, the link member 34 can be stably rotated by the rotational support of the retaining portion 54 when the rotating shaft 31 is rotated.

According to this embodiment, as hereinabove described, the retaining portion 54 includes the recess portion having the circular inner peripheral surface 54a rotatably supporting the engaging portion 43 having the circular outer periphery 43a and the bottom portion 54b. Furthermore, the retaining portion 54 is configured to restrict the movement of the link member 34 in the outward direction (direction X1) opposite to the rotating shaft 31 by the bottom portion 54b of the retaining portion 54. Thus, the engaging portion 43 can be rotatably supported by the inner peripheral surface 54a of the retaining portion 54, and the engaging portion 43 (link member 34) can be retained by the bottom portion 54b of the retaining portion 54. Consequently, by a simple structure of simply forming the retaining portion 54 including the recess portion, the link member 34 can be retained while the link member 34 can be rotatably supported.

According to this embodiment, as hereinabove described, the bottom portion 54b of the retaining portion 54 is tapered rearward, and the edge 43c of the tip end portion 43b is configured to come into contact with the tapered bottom portion 54b when the engaging portion 43 of the link member 34 is moved in the outward direction (direction X1). Thus, also in a state where the link member 34 is retained by the retaining portion 54, the edge 43c of the tip end portion 43b of the engaging portion 43 simply comes into contact with the tapered bottom portion 54b in a line-contact state or in a state close to line contact, and hence an increase in a contact area between the link member 34 and the retaining portion 54 can be suppressed. Consequently, an increase in sliding resistance at the time of rotation of the link member 34 can be suppressed in a state where the link member 34 is retained by the contact of the link member 34 with the retaining portion 54.

According to this embodiment, as hereinabove described, the rotating shaft mounting portion 41 mounted with the end of the rotating shaft 31 is provided in the end of the link member 34 closer (X2 direction side) to the rotating shaft 31. Furthermore, the engaging portion 43 is provided in the end of the link member 34 opposite (X1 direction side) to the rotating shaft 31. In addition, the rotating shaft mounting portion 41 and the engaging portion 43 of the link member 34 are rotatably supported by the slide bearing member 36 and the retaining portion 54, respectively such that the structure of bearing both ends of the link member 34 is formed. Thus, both ends of the link member 34 are supported by the slide bearing member 36 and the retaining portion 54 so that the link member 34 can be borne. In the case where the rotation of the link member 34 is supported in a cantilever manner by only one bearing provided in a connection between the link member 34 and the rotating shaft 31, for example, a lateral load (radial load) in a direction orthogonal to the rotating shaft 31 on the side of the link member 34 opposite (Y1 direction side) to the rotating shaft 31 must also be supported by one bearing on the base side, and hence a ball bearing or the like having small sliding resistance must be employed. On the other hand, according to this embodiment, a load can be distributed by bearingly supporting both ends of the link member 34, and hence a slide bearing having a simple structure, being inexpensive as compared with the ball bearing can also be employed to provide sufficiently stable support. Thus, a bearing component of the rotating shaft 31 can be simplified while the reliability of the rotatable support of the link member 34 is ensured.

According to this embodiment, as hereinabove described, the engaging portion 43 of the link member 34 and the retaining portion 54 are made of resin, and the retaining portion 54 is configured to support the engaging portion 43 to be slidable in the rotational direction. Thus, the rotation of the engaging portion 43 is supported by the sliding between the resins when the rotation of the engaging portion 43 is supported by the retaining portion 54, and hence it is not necessary to separately provide a bearing member in the retaining portion 54. Therefore, the rotation of the engaging portion 43 can be supported by the retaining portion 54 without increasing the number of components. In light of sliding performance between resins, better sliding performance and better abrasion resistance performance can be obtained between two members in the case where nylon 6 and nylon 6,6 are slid to each other than in the case where the same types of nylon (nylon 6 and nylon 6 or nylon 6,6 and nylon 6,6, for example) are slid to each other. Thus, it is preferable that one of the engaging portion 43 (link member 34) made of resin and the retaining portion 54 (case portion 52) made of resin be made of nylon 6 and the other of the engaging portion 43 and the retaining portion 54 be made of nylon 6,6, for example.

According to this embodiment, as hereinabove described, the rotating shaft 31 made of metal is formed in the same sectional shape that is not varied, the rotating shaft 31 is mounted on the end of the link member 34 closer (X2 direction side) to the rotating shaft 31, and the engaging portion 43 and the connection portion 42 are provided in the end of the link member 34 opposite (X1 direction side) to the rotating shaft 31. Thus, no engaging structure for the retaining of the link member 34 is formed in the rotating shaft 31 made of metal, and hence the link member 34 can be reliably retained by the engagement of the engaging portion 43 in the end of the link member 34 opposite (X1 direction side) to the rotating shaft 31 with the retaining portion 54 without increasing the number of processing steps for the rotating shaft 31 made of metal.

The embodiment disclosed this time must be considered as illustrative in all points and not restrictive. The range of the present invention is shown not by the above description of the embodiment but by the scope of claims for patent, and all modifications within the meaning and range equivalent to the scope of claims for patent are further included.

For example, while the example of applying the air intake control valve according to the present invention to the air intake apparatus of the automotive four-cylinder engine has been shown in the aforementioned embodiment, the present invention is not restricted to this. The air intake control valve according to the present invention may be applied to an air intake apparatus of an internal-combustion engine other than the automotive engine, or the air intake control valve according to the present invention may be applied to an air intake apparatus of a multiple cylinder engine or the like other than the four-cylinder engine.

While the example of applying the present invention to the air intake control valve for changing the air intake path lengths of the air intake ports has been shown in the aforementioned embodiment, the present invention is not restricted to this. The present invention may be applied to an air intake control valve employed in a TCV (tumble control valve) for generating tumble flow in a cylinder of an engine or an SCV (swirl control valve) for generating swirl flow in a cylinder of an engine, for example.

While the example of integrally forming the retaining portion in the case portion of the actuator has been shown in the aforementioned embodiment, the present invention is not restricted to this. According to the present invention, the retaining portion may be provided separately from the case portion of the actuator. In this case, the retaining portion may be separately mounted on the case portion, or the retaining portion may be fixed to the air intake apparatus body separately from the case portion.

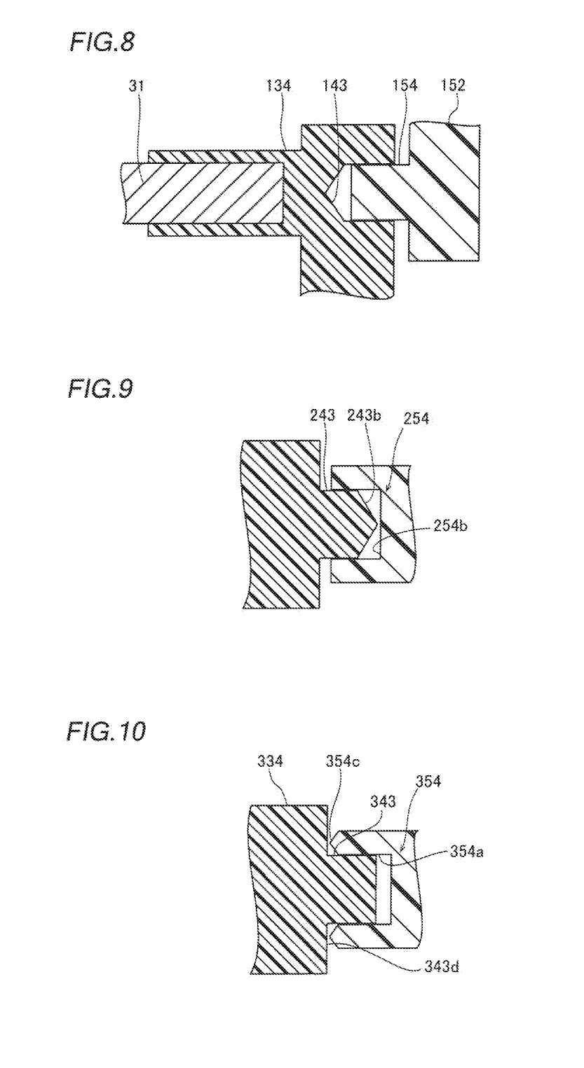

While the example of providing the engaging portion including the shaft-shaped protrusion in the link member has been shown in the aforementioned embodiment, the present invention is not restricted to this. The engaging portion may not be a shaft-shaped protrusion. For example, as in a modification of the link member shown in FIG. 8, an engaging portion 143 of a link member 134 may include a cylindrical recess portion. In this case, a retaining portion 154 of a case portion 152 may include a shaft-shaped protrusion, and the engaging portion 143 and the retaining portion 154 may engage with each other. Furthermore, in this case, a bottom portion of the engaging portion 143 including the recess portion may be tapered (tapered rearward), as shown in FIG. 8.

While the example of arranging the engaging portion of the link member coaxially on the rotation centerline C of the rotating shaft has been shown in the aforementioned embodiment, the present invention is not restricted to this. According to the present invention, the engaging portion of the link member may not be arranged coaxially with the rotating shaft.

While the example of providing the engaging portion having the flat tip end portion and the retaining portion having the bottom portion tapered rearward has been shown in the aforementioned embodiment, the present invention is not restricted to this. The bottom portion of the retaining portion may not be tapered. In other words, as in a first modification of an engaging portion and a retaining portion shown in FIG. 9, a tip end portion 243b of an engaging portion 243 may be in a tapered convex shape, and a bottom portion 254b of a retaining portion 254 may be flattened. Alternatively, in contrast to this first modification, a tip end portion of an engaging portion may be flattened, and a bottom portion of a retaining portion may be in a tapered convex shape protruding to the open side. The engaging portion 243 is an example of the “shaft-shaped protrusion portion” in the present invention. The retaining portion 254 is an example of the “recess portion” in the present invention.

While the example in which the bottom portion of the retaining portion including the recess portion and the tip end portion of the engaging portion come into contact with each other so that the link member is retained has been shown in the aforementioned embodiment, the present invention is not restricted to this. The retaining portion may be configured to retain the link member by a portion other than the bottom portion. As in a second modification of an engaging portion and a retaining portion shown in FIG. 10, for example, an annular convex portion 354c may be provided on an end surface of a retaining portion 354 including a recess portion closer to a link member 334, and this convex portion 354c and a base portion 343d (an end surface of the link member 334 closer to the retaining portion 354) of an engaging portion 343 may come into contact with each other so that the link member 334 is retained. Also in this case, the engaging portion 343 may include a shaft-shaped protrusion, and the engaging portion 343 may be borne by the inner peripheral surface 354a of the retaining portion 354. Alternatively, in contrast to this second modification, a convex portion protruding toward a retaining portion may be formed in a base portion of an engaging portion. The engaging portion 343 is an example of the “shaft-shaped protrusion portion” in the present invention.

While the example in which the retaining portion including the recess portion retains the link member (engaging portion) by the bottom portion and rotatably supports (bears) the engaging portion by the inner peripheral surface has been shown in the aforementioned embodiment, the present invention is not restricted to this. According to the present invention, the engaging portion may not be borne by the inner peripheral surface of the retaining portion. For example, the retaining portion may simply come into contact with an end surface of the engaging portion for retaining. At this time, it is only required to configure the retaining portion to allow the rotation of the link member.

While the example in which the rotation of the rotating shaft mounting portion of the link member is supported by the slide bearing member made of metal and the rotation of the engaging portion is supported by the retaining portion made of resin has been shown in the aforementioned embodiment, the present invention is not restricted to this. For example, the slide bearing member made of metal may be provided also in the retaining portion. Reversely, the rotation of the rotating shaft mounting portion may be supported by the bearing member made of resin. In addition to this, a bearing of the rotating shaft mounting portion may be a ball bearing or the like other than the slide bearing.

While the example of providing the negative pressure actuator as an actuator generating drive force in the linear direction has been shown in the aforementioned embodiment, the present invention is not restricted to this. The actuator may be any kind of actuator so far as the same generates drive force in the linear direction. For example, the actuator may include a direct acting mechanism employing a solenoid valve or a torque motor.

While the example of providing the rotating shaft having the same sectional shape that is not varied over the entire length has been shown in the aforementioned embodiment, the present invention is not restricted to this. According to the present invention, a rotating shaft having a varied sectional shape may be provided.

### REFERENCE NUMERALS

2: air intake port
3: air intake control valve
31: rotating shaft
32: valve body
33: actuator
34, 134, 334: link member
41: rotating shaft mounting portion
41a: press-fit hole
42: connection portion (actuator connection portion)
43, 243, 343: engaging portion (shaft-shaped protrusion portion)
43b: tip end portion
43c: edge
52: case portion
54, 254: retaining portion (recess portion)
54a, 354a: inner peripheral surface
54b, 254b: bottom portion
36: slide bearing member
143: engaging portion
154, 354: retaining portion

1. An air intake control valve comprising:
a valve body provided in an air intake port;
a rotating shaft rotating together with the valve body;
an actuator generating drive force in a linear direction;
a link member having an engaging portion provided on a side opposite to the rotating shaft and an actuator connection portion connected to the actuator, connecting the rotating shaft and the actuator to convert the drive force of the actuator in the linear direction into drive force in a rotational direction and transmit the drive force that has been converted to the rotating shaft; and
a retaining portion engaging with the engaging portion to restrict movement of the engaging portion of the link member in an outward direction while allowing rotation of the engaging portion of the link member.

2. The air intake control valve according to claim 1, wherein
the actuator integrally includes the retaining portion.

3. The air intake control valve according to claim 2, wherein
the actuator includes a case portion made of resin, and
the retaining portion is made of resin and is integrally provided in the case portion of the actuator.

4. The air intake control valve according to claim 1, wherein
the engaging portion includes a shaft-shaped protrusion portion provided on a rotation centerline of the rotating shaft, having a circular outer periphery, and
the retaining portion rotatably supports the shaft-shaped protrusion portion.

5. The air intake control valve according to claim 4, wherein
the retaining portion includes a recess portion having a circular inner peripheral surface rotatably supporting the shaft-shaped protrusion portion having the circular outer periphery and a bottom portion and restricts movement of the link member in the outward direction opposite to the rotating shaft by the bottom portion of the recess portion.

6. The air intake control valve according to claim 5, wherein
the bottom portion of the recess portion constituting the retaining portion is tapered rearward, and
an edge of a tip end portion of the shaft-shaped protrusion portion comes into contact with the bottom portion that is tapered when the shaft-shaped protrusion portion of the link member is moved in the outward direction.

7. The air intake control valve according to claim 4, wherein
an end of the link member closer to the rotating shaft is provided with a rotating shaft mounting portion mounted with an end of the rotating shaft, and an end of the link member opposite to the rotating shaft is provided with the shaft-shaped protrusion portion, and
the rotating shaft mounting portion of the link member has a press-fit hole into which the rotating shaft is pressed and has a circular outer peripheral surface,
the air intake control valve further comprising a cylindrical slide bearing member rotatably supporting the outer peripheral surface of the rotating shaft mounting portion of the link member, wherein
the rotating shaft mounting portion and the shaft-shaped protrusion portion of the link member are rotatably supported by the slide bearing member and the retaining portion, respectively, such that a structure of bearing both ends of the link member is formed.

8. The air intake control valve according to claim 1, wherein
the engaging portion of the link member and the retaining portion are made of resin, and
the retaining portion supports the engaging portion to be slidable in the rotational direction.

9. The air intake control valve according to claim 1, wherein
the rotating shaft is made of metal,
at least a region of the rotating shaft made of metal on a side to which the link member is connected has a same sectional shape that is not varied, and
an end of the link member closer to the rotating shaft is mounted with the rotating shaft, and an end of the link member opposite to the rotating shaft is provided with the engaging portion and the actuator connection portion.
